(19) United States
(12) Patent Application Publication
(10) Pub. No.: US 2025/0130999 A1
(43) Pub. Date: Apr. 24, 2025

(54) METHODS AND APPARATUS TO COMPRESS TABULAR GEOSPATIAL DATA

(71) Applicant: Deere & Company, Moline, IL (US)

(72) Inventors: Ryan Kirk, Urbandale, IA (US); Mo Fotouhi, Madison, WI (US); Jared Grove, Saint Charles, IA (US); Matthew Burke, Denver, CO (US)

(21) Appl. No.: 18/765,030

(22) Filed: Jul. 5, 2024

Related U.S. Application Data
(60) Provisional application No. 63/591,830, filed on Oct. 20, 2023.

(51) Int. Cl. G06F 16/2455

(52) U.S. Cl. CPC G06F 16/24561

(57) ABSTRACT

Systems, apparatus, articles of manufacture, and methods are disclosed to compress geospatial data. An example apparatus to compress geospatial data comprises circuitry to instantiate machine-readable instructions to: cause compression of first data and second data responsive to a query to compress data for a plot of land using a compression technique, the compression of the first data and the second data to generate a first compressed data set and a second compressed data set; extract features from the first compressed data set and the second compressed data set; and combine features from the first compressed data set and the second compressed data set to generate a set of geospatial features.

### RELATED APPLICATION

This patent claims the benefit of U.S. Provisional Patent Application No. 63/591,830, which was filed on Oct. 20, 2023. U.S. Provisional Patent Application No. 63/591,830 is hereby incorporated herein by reference in its entirety. Priority to U.S. Provisional Patent Application No. 63/591,830 is hereby claimed.

### FIELD OF THE DISCLOSURE

This disclosure relates generally to compression of tabular geospatial data and, more particularly, to methods and apparatus to compress tabular geospatial data for use in determining boundaries and subzones for machine operation.

### BACKGROUND

In recent years, vehicles have become increasingly automated. As one example, agricultural vehicles may semi-autonomously or fully-autonomously drive and perform operations on plots of land. When driving and performing operations on plots of land, agricultural vehicles may receive maps to guide their path. Agricultural vehicles perform operations using implements including planting implements, spraying implements, harvesting implements, fertilizing implements, strip/till implements, etc. The control of these implements may be determined based on the position of the agricultural vehicle on the plot of land. These autonomous agricultural vehicles include multiple sensors to help navigate without assistance, or with limited assistance, from human users.

### BRIEF DESCRIPTION OF THE DRAWINGS

FIG. 1 is a block diagram of an example environment in which an example vehicle operates according to boundaries.

FIG. 2 is an example circuitry diagram of the example server of FIG. 1.

FIG. 3 is a block diagram representative of example programmable circuitry structured to execute, instantiate, and/or perform the example machine-readable instructions and/or perform the example operations to implement the geospatial data compression circuitry of FIG. 2.

FIG. 4 is a first flowchart representative of example machine-readable instructions and/or example operations that may be executed, instantiated, and/or performed by example programmable circuitry, the geospatial data compression circuitry of FIG. 2.

FIG. 5 is a second flowchart representative of example machine-readable instructions and/or example operations that may be executed, instantiated, and/or performed by example programmable circuitry, the geospatial data compression circuitry of FIG. 2.

FIG. 6 is a flowchart representative of example machine-readable instructions and/or example operations that may be executed, instantiated, and/or performed by example programmable circuitry to implement the determination of data sets from a query of FIG. 5.

FIG. 7 is a flowchart representative of example machine-readable instructions and/or example operations that may be executed, instantiated, and/or performed by example programmable circuitry to implement the compression of data according to user query and data type of FIG. 5.

FIG. 8 is a flowchart representative of example machine-readable instructions and/or example operations that may be executed, instantiated, and/or performed by example programmable circuitry to implement the extraction of key features from the compressed data of FIG. 5.

FIG. 9 is a block diagram of an example processing platform including programmable circuitry structured to execute, instantiate, and/or perform the example machine-readable instructions and/or perform the example operations of FIGS. 4-8 to implement the geospatial compression circuitry of FIG. 2.

FIG. 10 is a block diagram of an example implementation of the programmable circuitry of FIG. 9.

FIG. 11 is a block diagram of another example implementation of the programmable circuitry of FIG. 9.

FIG. 12 is a block diagram of an example software/firmware/instructions distribution platform (e.g., one or more servers) to distribute software, instructions, and/or firmware (e.g., corresponding to the example machine-readable instructions of FIGS. 4-8) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Automation of vehicles is desired. Such vehicle automation improves the accuracy of the performance of operations, reduces operator fatigue, improves efficiency, and accrues other benefits. In particular, the automation of agricultural vehicles has beneficial secondary effects such as efficiency of agricultural operations and/or precise placement of agricultural material.

The automation of vehicles across a plot of land having different conditions, requirements, or operations, requires boundaries that dictate the travel and operation of the vehicle throughout subzones. As discussed herein, a boundary is a border between adjacent regions of a plot of land, wherein the regions encompassed by the boundaries are subzones. One type of subzone is an exclusion zone in which the vehicle may not perform any, or may only perform a certain, agricultural operation(s). Exclusion zones may be fixed and applied to all operations. In other examples, exclusion zones may only apply to certain activities, like tillage, and allow other activities, like traversal. Some exclusion zones are temporary, such as when the field is too muddy to permit traversal and are removed when the plot of land dries.

While the creation of boundaries and subzones for machine operation is highly advantageous, current methods are burdensome as the boundaries may be created from tabular geospatial data. However, working with tabular geospatial data is challenging. First, tabular geospatial data contains numerous redundant data points that make the dataset large and difficult to manage. Second, transferring large tabular datasets is time-consuming, especially when dealing with remote teams or clients. Third, visualization of an entire tabular geospatial data set, which is necessary to help detect patterns, relationships, and trends, is very difficult. Lastly, tabular datasets are costly to store and process.

The boundaries come from a variety of sources. These boundaries can be hand-drawn (e.g., using mapping software), machine-generated, algorithmically developed (e.g., based on historical travel paths), etc. Consequently, a process to combine existing boundaries is necessary. Then, during combination, confidence in a boundary determines when a plot of land is ready for automation. Conventional boundary combination methods can combine boundaries but are unable to express a confidence in each boundary during combination.

The boundaries define subzones and exclusion zones. Conventional subzones for vehicle operation rely on a method where the vehicle is controlled to perform a certain operation while traveling between each boundary. In doing so, the presence of hazards or natural obstacles is difficult to detect and account for in an autonomous operation. Conventional subzones do not account for areas where the actual boundary of the plot of land is uncertain in a region. In areas where the boundary is uncertain, the operator of the vehicle must use a judgment call of where to travel. Uncertainty of a boundary may arise from discrepancies between data from outside sources (e.g., map data, satellite data, etc.) and the actual conditions of the specific plot of land. Example conditions giving rise to regions of interest for placement of a boundary include regions of a plot of land with characteristics that will result in poor outcomes (poor soil, low moisture, etc.), natural obstacles (trees, streams, steep slopes, etc.), trial zones, and hazards (such as, spraying in residential areas, etc.).

The examples disclosed herein allow for compression of tabular geospatial data sets to analyze a plot of land and produce a set of geospatial features that correspond to the plot of land. As used herein, a plot of land refers to a portion of land about which the user wishes to obtain information, data sets, boundaries, etc. Then, this set of geospatial features is used to generate subzones within which machine operations (e.g., machine travel, agricultural operations, etc.) are assigned. After assignment of machine operations, an autonomous vehicle can navigate the plot of land performing the assigned machine operations per each subzone.

Along with other sources of data, generated subzones may be used to generate a soft boundary. As used herein, a soft boundary is a probabilistic boundary. This probabilistic boundary may be created from a combination of existing boundaries from different sources with weighted confidences to return a combined boundary. As a result of the combination, each point along the combined boundary has a distribution of possible locations.

The disclosed systems and methods address issues of the conventional approaches. Particularly, the solution herein allows for the creation of exclusion zones where machine operation is not necessary, but still accounted for, in the plot of land.

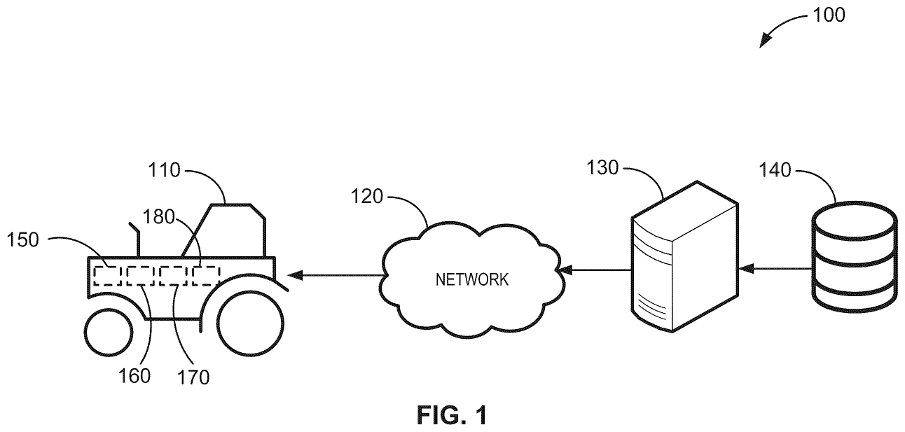

FIG. 1 is a block diagram of an example operational environment 100. An example vehicle 110 is in communication with a network 120, which is also in communication with one or more servers 130. The server 130 utilizes one or more databases 140 to store information used to determine boundaries. In one example, the server 130 accesses information from the database 140 and determines one or more boundaries, subzones, and/or exclusion zones, which are communicated through the network to the vehicle 110.

As shown in the example of FIG. 1, the vehicle 110 includes an example position determination system 150, an example navigation system 160, an example data store 170, and an example communication system 180. The communication system 180 receives the boundary information from the server 130 via the network 120 and stores the same in the data store 170. In some examples, data collected by the position determining system 150 may be sent back to the server 130 via the network 120. The navigation system 160, which may include an automated driving functionality, controls navigation of the vehicle 110 in accordance with the information in the data store 170, including boundaries, subzones, exclusion zones, etc. Thus, the vehicle operations are controlled in accordance with the boundaries generated by the server 130.

The example vehicle 110 of FIG. 1 may be an agricultural vehicle (e.g., a tractor, a front loader, a harvester, a cultivator, a mower, or any other suitable vehicle), a construction vehicle, a forestry vehicle, or other work vehicle. In the example of FIG. 1, the vehicle 110 is represented as a tractor; however, other vehicles may additionally or alternatively be included. The vehicle 110 can move between different locations and over different terrain.

The example network 120 of FIG. 1 shuttles communication between the server 130 and the example vehicle 110. The example network 120 may be implemented by wireless communication, satellite communication, or other suitable communication modes.

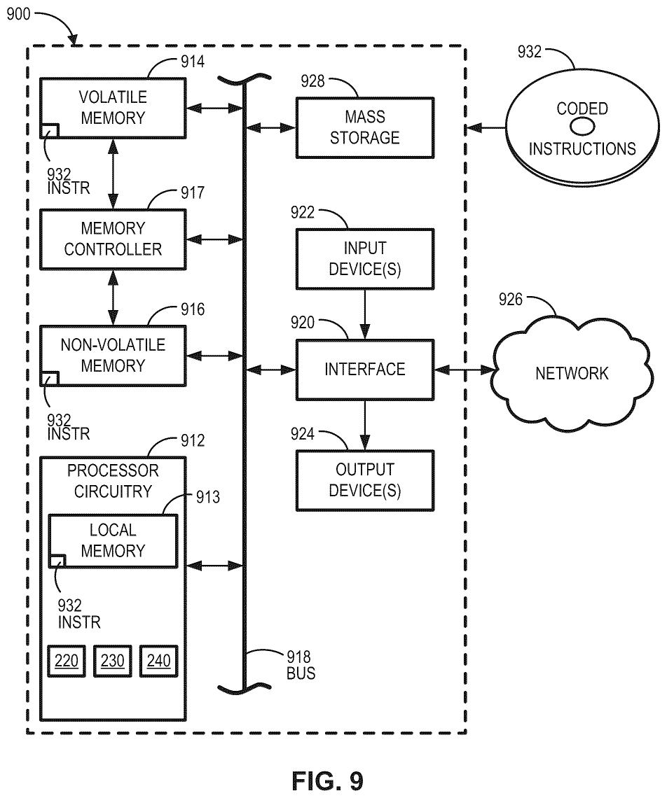

The example server 130 of FIG. 1 may be instantiated, implemented, or performed as described in connection with the processor circuitry of FIGS. 9-12.

The example database 140 of FIG. 1 stores information concerning plots of land, machine operations, etc., for use by the server 130. The example database 140 may be implemented by magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

While in the example of FIG. 1, the server 130 and the database 140 are shown separate from the vehicle 110, in other examples the functionality described herein as associated with the server may be implemented within the vehicle 110. For example, the vehicle 110 may be equipped with processing power, such as a server, and data storage, such as a database, to implement the functions associated with the server 130 and the database 140 described herein.

In FIG. 1, the example position determination system 150 may be a GNSS receiver included in the vehicle 110. This example position determination system 150 may be equipped with Global Navigation Satellite System (GNSS), Global Positioning Systems (GPS), Light Detection and Ranging (LIDAR), Radio Detection and Ranging (RADAR), Sound Navigation and Ranging (SONAR), telematics sensors, etc. In some examples, the example GNSS receiver may use differential correction such as (a) precise point positioning (PPP) mode or wide area augmentation, or (b) RTK (real time kinematic) mode. The RTK system or mode requires at least one local base station that provides correction information wirelessly to the GNSS receiver with a wireless communications device that can receive correction data from the local base station in RTK. Similarly, for the GNSS receiver operating as PPP or PPP mode has a network of reference GNSS stations at known locations that provide a correction signal to the GNSS receiver on the vehicle 110 via a wireless communications device, such as satellite communications device. In some examples, this position determination system 150 may be connected to a central server (e.g., John Deere Operations Center “OpsCenter”, server 130 of FIG. 1, etc.) where collected boundary data and collected subzone data are stored from past operations on that plot of land. Each time the same plot of land has equipment travel over the land or perform an operation on that land, such as tilling, planting, spraying, harvesting, or performing other work tasks, boundary data is collected to be stored in the database 140 for use in successive agricultural operations.

The navigation system 160 receives, processes, and transmits example instructions to control operation of the vehicle 110. The navigation system 160 may also receive instructions to perform various machine operations such as, tilling, planting, spraying, harvesting, or other work tasks. Additionally or alternatively, the navigation system 160 may transmit information of the terrain and machine operation performed for a specific plot of land to the server 130.

The data store 170 receives, processes, and transmits example instructions from the server 130. The data store 170 may be a memory, and store instructions for later or contemporary use by the vehicle 110. The instructions contained in the data store 170 may correspond to vehicle operation instructions and/or collected data from the plot of land.

The communication system 180 receives, processes, and transmits example instructions from the server 130 to the data store 170 and the navigation system 160. The communication system 180 may communicate instructions concerning boundaries, maps, sensor data, etc. The communication system may be implemented as a wireless system, a cellular system, a satellite system, a radio system, etc.

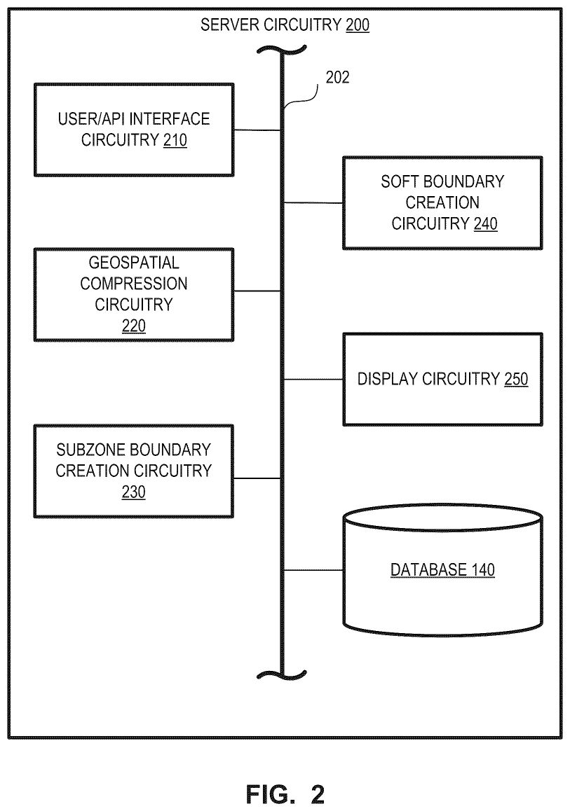

FIG. 2 is a block diagram representative of example server circuitry 200 to implement the server 130 of FIG. 1. The components of the example server circuitry 200 are connected by an example bus 202. The user/API interface circuitry 210 receives a user request for compressed data and/or boundaries/subzones within a plot of land. The geospatial compression circuitry 220 compresses the data for use in later implementations and may extract features for a requested plot of land. The subzone boundary creation circuitry 230 may use the compressed data or set of geospatial features to detect differing values (e.g., subzones) within the dataset to prescribe differing machine operations based on the detected values. The soft boundary creation circuitry 240 generates soft boundaries for use in applications such as subzone detection and other boundary applications. The soft boundary creation circuitry 240 may use compressed data from the geospatial compression circuitry. Additionally or alternatively, the soft boundary creation circuitry 240 may generate soft boundaries to be used by the subzone boundary creation circuitry 230. Upon generation of a compressed data set, a set of geospatial features, a subzone, or a soft boundary, the display circuitry 250 may display the result. Lastly, the compressed data set, the set of geospatial features, the subzone, or the soft boundary may be stored in the database 140. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example server 130 of FIG. 1 may be instantiated (e.g., creating an instance of, bring into being for any length of time, materialize, implement, etc.) by programmable circuitry such as a Central Processor Unit (CPU) executing first instructions. Additionally or alternatively, the example server 130 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

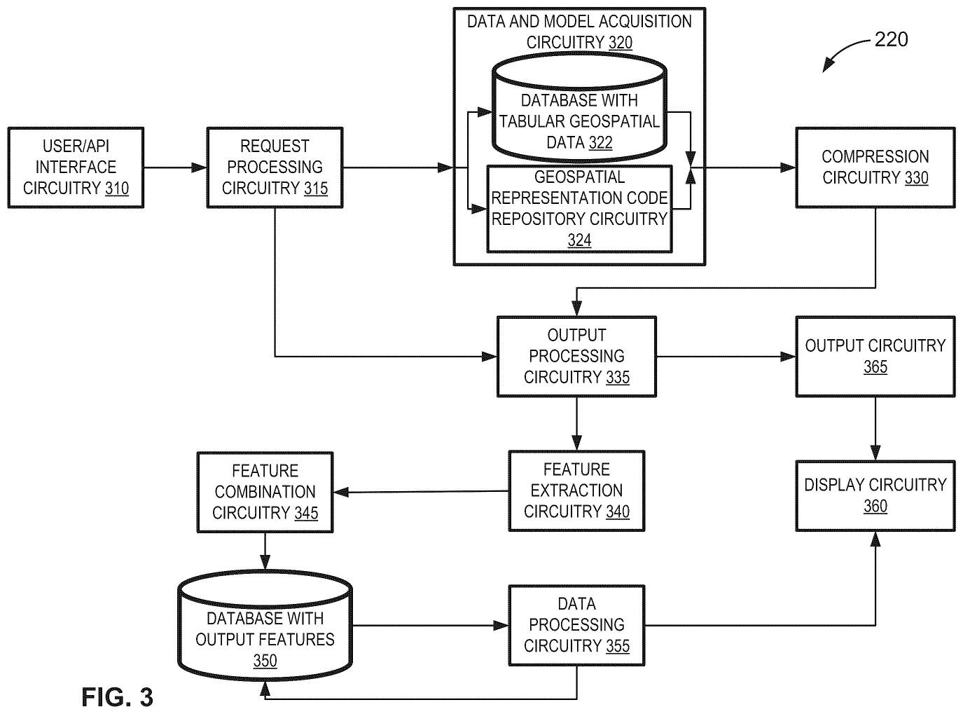

FIG. 3 is a block diagram representative of an example implementation of the server 130 of FIG. 1 to instantiate the geospatial compression circuitry 220 of FIG. 2. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

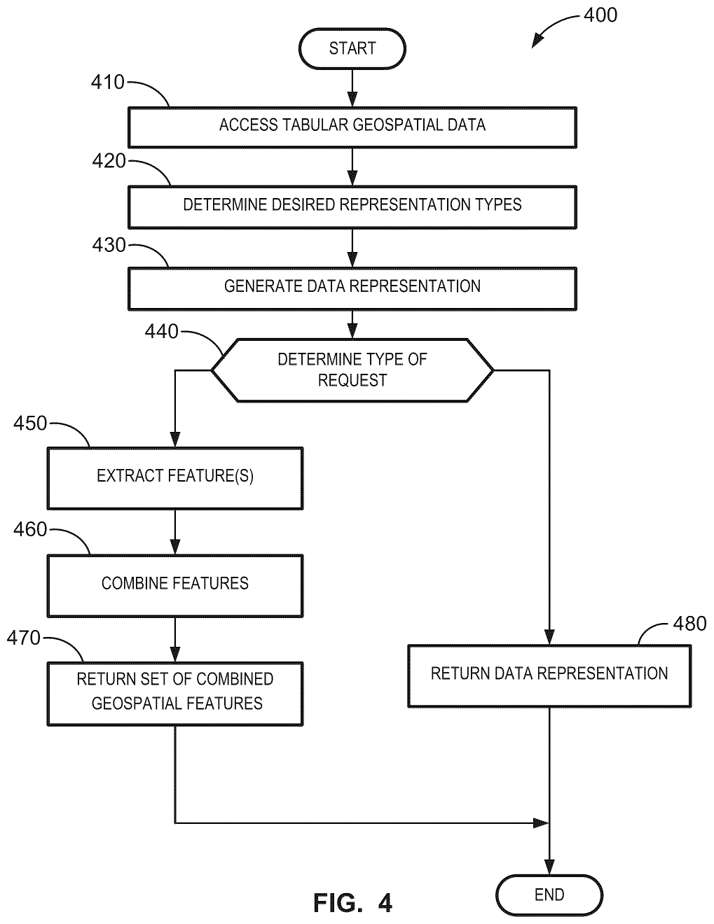

The process of geospatial compression starts with an input to the user or application programming interface (API) interface circuitry 310. The user/API interface circuitry 310 receives a query for the compression of tabular geospatial data corresponding to a plot of land with georeferenced coordinates. As used herein, georeferenced coordinates may include a global coordinate system and/or a local coordinate system. In some examples, georeferenced coordinates may include latitude and longitude coordinates. This interface may be instantiated with a web application consisting of an interface to enter the request or an API that another program or technique calls from. The user/API interface circuitry 310 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. Additionally, the input device(s), user/API interface circuitry 310, can be implemented by, for example, an audio sensor, a microphone, a camera (still or video), a keyboard, a button, a mouse, a touchscreen, a trackpad, a trackball, an isopoint device, and/or a voice recognition system. In some examples, the user/API interface circuitry 310 is instantiated by programmable circuitry executing interface instructions and/or configured to perform operations such as those represented by the flowchart of FIG. 4 (block 410).

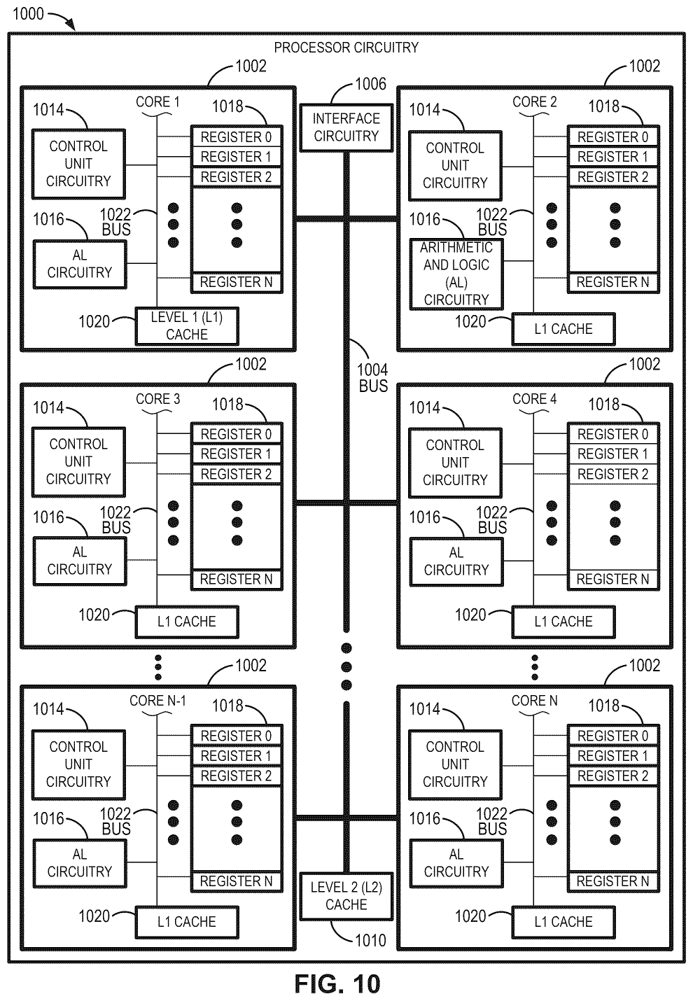

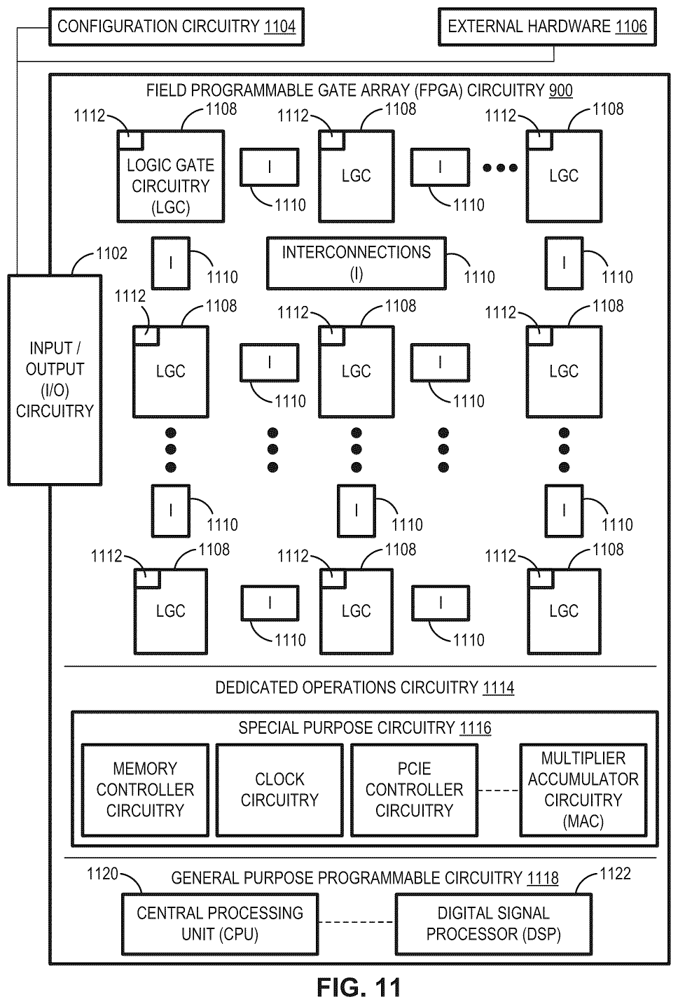

In some examples, the geospatial compression circuitry 220 includes means for receiving a query for compression of tabular geospatial data corresponding to a plot of land. For example, the means for receiving the query may be implemented by user/API interface circuitry 310. In some examples, the user/API interface circuitry 310 may be instantiated by programmable circuitry such as the example programmable circuitry 912 of FIG. 9. For instance, the user/API interface circuitry 310 may be instantiated by the example microprocessor 1000 of FIG. 10 executing machine executable instructions such as those implemented by at least block 410 of FIG. 4. In some examples, the user/API interface circuitry 310 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the user/API interface circuitry 310 may be instantiated by any other combination of hardware, software, and/or firmware. For example, the user/API interface circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

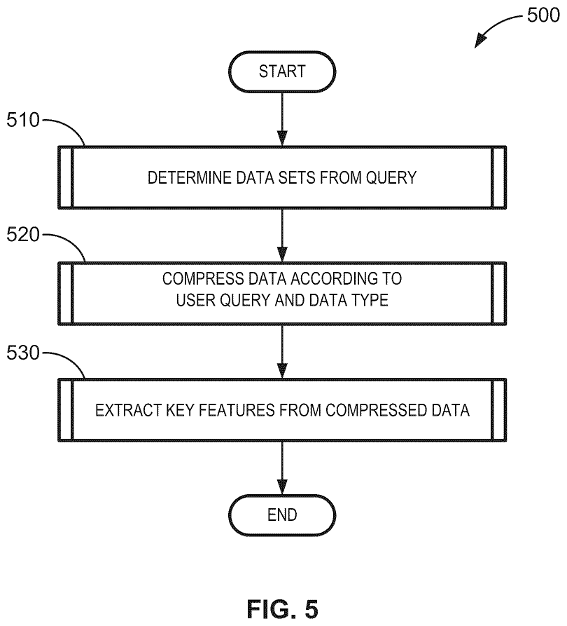

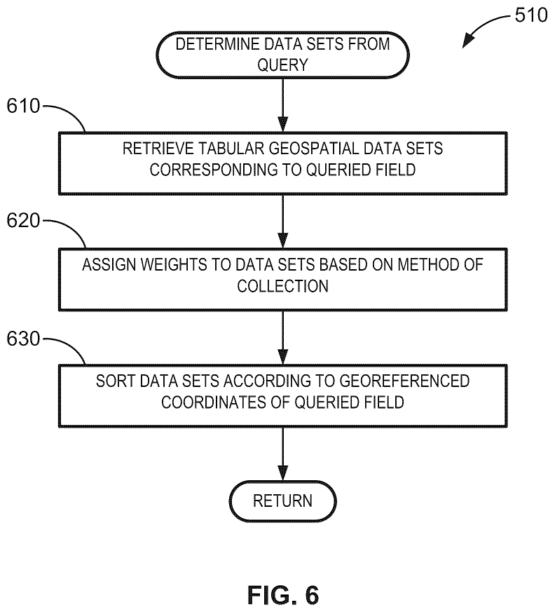

Then, the user/API interface circuitry 310 relays this query to the request processing circuitry 315. The request processing circuitry 315 determines data in response to the request for compression of tabular geospatial data corresponding to the plot of land. After determining the data responsive to the request, the request processing circuitry 315 relays the identity of the data to the data and model acquisition circuitry 320. Additionally, the request processing circuitry 315 may also relay the identity of the data to the output processing circuitry 335. The identity of the data to the output processing circuitry 335 may also include whether new features are to be created and stored or are just temporarily needed. In some examples, the request processing circuitry 315 is instantiated by programmable circuitry executing request processing instructions and/or configured to perform operations such as those represented by the flowcharts of FIG. 4 (block 410), FIG. 5 (block 510), and FIG. 6 (block 610).

In some examples, the geospatial compression circuitry 220 includes means for determining data responsive to a request. For example, the means for determining the data responsive to the request may be implemented by request processing circuitry 315. In some examples, the request processing circuitry 315 may be instantiated by programmable circuitry such as the example programmable circuitry 912 of FIG. 9. For instance, the request processing circuitry 315 may be instantiated by the example microprocessor 1000 of FIG. 10 executing machine executable instructions such as those implemented by at least block 410 of FIG. 4, block 510 of FIG. 5, and block 610 of FIG. 6. In some examples, the request processing circuitry 315 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the request processing circuitry 315 may be instantiated by any other combination of hardware, software, and/or firmware. For example, the request processing circuitry 315 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

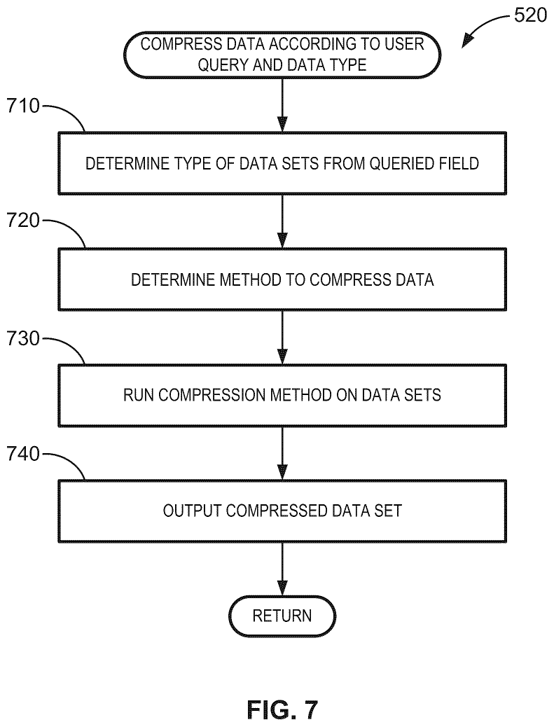

The data and model acquisition circuitry 320 receives the request from the request processing circuitry 315 and retrieves data from the database with tabular geospatial data 322 and code corresponding to a compression technique from the geospatial representation code repository circuitry 324. The data and model acquisition circuitry 320 finds the relevant data from the database with tabular geospatial data 322 and the geospatial representation code repository circuitry 324. In some examples, the data and model acquisition circuitry 320 assigns weights to data sets based on a method of collection of the data, and sorts data sets according to georeferenced coordinates of the plot of land. The database with tabular geospatial data 322 contains tabular geospatial data. Tabular geospatial data from the plot of land may include, but is not limited to boundaries of the land, soil zones, soil survey data, soil moisture data, soil nutrient data, crop data, crop yield data, crop vigor/size within plant zones, crop inputs (e.g., pesticides, insecticides, fungicides, fertilizer, nutrients) for respective zones, seed/plant density per field zone, seed genetic profile for a corresponding zone, agronomic practices per field/zone, etc. In some examples, boundaries of land could be combined with plant zones or crop treatment zones across a span of time (e.g., several years) to form a more accurate representation of potential clusters/subzones within a boundary. The geospatial representation code repository circuitry 324 contains code for various geospatial compression or representation techniques, as disclosed above. In some examples, the geospatial representation code repository circuitry 324 determines a method to compress data based on the relevant data (e.g., the type of data, the quantity of data, etc.) pulled from the database with tabular geospatial data 322. In some examples, the data and model acquisition circuitry 320 is instantiated by programmable circuitry executing data and model acquisition instructions and/or configured to perform operations such as those represented by the flowcharts of FIG. 4 (block 420) and FIG. 7 (blocks 710-720).

In some examples, the geospatial compression circuitry 220 includes means for determining data and a model responsive to a request. For example, the means for determining data and the model responsive to the request may be implemented by data and model acquisition circuitry 320. In some examples, the data and model acquisition circuitry 320 may be instantiated by programmable circuitry such as the example programmable circuitry 912 of FIG. 9. For instance, the data and model acquisition circuitry 320 may be instantiated by the example microprocessor 1000 of FIG. 10 executing machine executable instructions such as those implemented by at least block 420 of FIG. 4 and blocks 710-720 of FIG. 7. In some examples, the data and model acquisition circuitry 320 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the data and model acquisition circuitry 320 may be instantiated by any other combination of hardware, software, and/or firmware. For example, the data and model acquisition circuitry 320 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

After the data and model acquisition circuitry 320 finds the relevant data and model in response to the user query, the data is sent to the compression circuitry 330. The compression circuitry 330 compresses the relevant data according to the model. In some examples, the compression circuitry 330 may be a compute cluster (either local or cloud based) that receives the code for the geospatial compression (representation) technique and the data responsive to the user query. Then, the compression circuitry 330 may install all dependencies for the requested compression (representation) techniques, import the data, and run the technique on the data. The technique to compress the data may be, but is not limited to, geo-index bucketing, rasterization, graph conversion, frequency domain conversion, auto-encoder, and Gaussian-mixture model (GMM) conversion. Then, the compression circuitry 330 sends the compressed data to the output processing circuitry 335. In some examples, the compression circuitry 330 is instantiated by programmable circuitry executing compression instructions and/or configured to perform operations such as those represented by the flowchart of FIG. 4 (block 430), FIG. 5 (block 520), and FIG. 7 (block 730).

In some examples, the geospatial compression circuitry 220 includes means for compressing data according to a determined model. For example, the means for compressing data according to the determined model may be implemented by compression circuitry 330. In some examples, the compression circuitry 330 may be instantiated by programmable circuitry such as the example programmable circuitry 912 of FIG. 9. For instance, the compression circuitry 330 may be instantiated by the example microprocessor 1000 of FIG. 10 executing machine executable instructions such as those implemented by at least block 430 of FIG. 4, block 520 of FIG. 5, and block 730 of FIG. 7. In some examples, the compression circuitry 330 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the compression circuitry 330 may be instantiated by any other combination of hardware, software, and/or firmware. For example, the compression circuitry 330 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

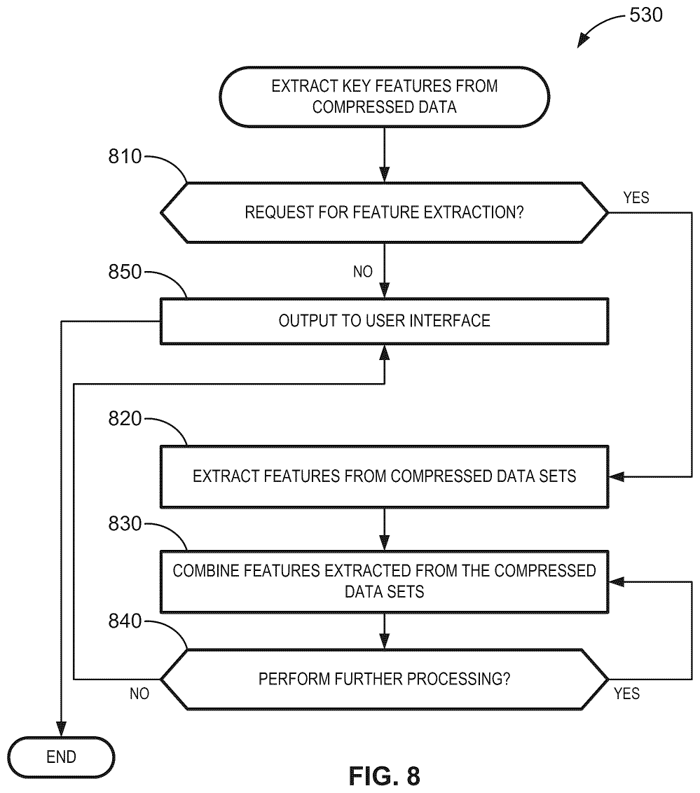

The output processing circuitry 335 receives the compressed data from the compression circuitry 330 and receives instructions for how the data is to be used from the request processing circuitry 315. If the data is to be stored and used again, the data may be sent to the feature extraction circuitry 340. If the data is not to be used again, the data is sent to the output circuitry 365. In some examples, the output processing circuitry 335 is instantiated by programmable circuitry executing output processing instructions and/or configured to perform operations such as those represented by the flowchart of FIG. 4 (block 440), FIG. 7 (block 740), and FIG. 8 (block 810).

In some examples, the geospatial compression circuitry 220 includes means for determining a use for a compressed data set. For example, the means for determining the use for the compressed data set may be implemented by output processing circuitry 335. In some examples, the output processing circuitry 335 may be instantiated by programmable circuitry such as the example programmable circuitry 912 of FIG. 9. For instance, the output processing circuitry 335 may be instantiated by the example microprocessor 1000 of FIG. 10 executing machine executable instructions such as those implemented by at least block 440 of FIG. 4, block 740 of FIG. 7, and block 810 of FIG. 8. In some examples, the output processing circuitry 335 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the output processing circuitry 335 may be instantiated by any other combination of hardware, software, and/or firmware. For example, the output processing circuitry 335 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The output circuitry 365 receives the data from the output processing circuitry 335. The output circuitry 365 may format the data for display and send the data to be output by the display circuitry 360. In some examples, the output circuitry 365 may display the compressed data set and/or an extracted feature set. The extracted feature set may include extracted data of the compressed data set. The display circuitry may be instantiated by the user/API interface circuitry 310, a machine display, a display on an agricultural vehicle, a mobile display, etc. In some examples, the output circuitry 365 is instantiated by programmable circuitry executing output instructions and/or configured to perform operations such as those represented by the flowchart of FIG. 7 (block 740) and FIG. 8 (block 850).

In some examples, the geospatial compression circuitry 220 includes means for displaying the compressed data set and/or an extracted feature set. For example, the means for displaying the compressed data set and/or an extracted feature set may be implemented by output circuitry 365. In some examples, the output circuitry 365 may be instantiated by programmable circuitry such as the example programmable circuitry 912 of FIG. 9. For instance, the output circuitry 365 may be instantiated by the example microprocessor 1000 of FIG. 10 executing machine executable instructions such as those implemented by at least block 740 of FIG. 7 and block 850 of FIG. 8. In some examples, the output circuitry 365 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the output circuitry 365 may be instantiated by any other combination of hardware, software, and/or firmware. For example, the output circuitry 365 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The feature extraction circuitry 340 receives the compressed data from the output processing circuitry 335. The feature extraction circuitry 340 employs a technique to generate a set of features from the compressed data. Various feature extraction methods may be used, as disclosed below. The extracted feature set is then sent to the feature combination circuitry 345. In some examples, the feature extraction circuitry 340 is instantiated, in part, by programmable circuitry executing feature extraction instructions and/or configured to perform operations such as those represented by the flowcharts of FIG. 4 (block 450), FIG. 5 (block 520), and FIG. 8 (block 820).

In some examples, the geospatial compression circuitry 220 includes means for extracting features from a compressed data set. For example, the means for extracting features from the compressed data set may be implemented by feature extraction circuitry 340. In some examples, the feature extraction circuitry 340 may be instantiated by programmable circuitry such as the example programmable circuitry 912 of FIG. 9. For instance, the feature extraction circuitry 340 may be instantiated by the example microprocessor 1000 of FIG. 10 executing machine executable instructions such as those implemented by at least block 450 of FIG. 4, block 520 of FIG. 5, and block 820 of FIG. 8. In some examples, the feature extraction circuitry 340 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the feature extraction circuitry 340 may be instantiated by any other combination of hardware, software, and/or firmware. For example, the feature extraction circuitry 340 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The feature combination circuitry 345 the extracted individual features of the extracted feature set may be flattened and consolidated in preparation to be stored. The consolidated feature set is then sent to the database with output features 350. In some examples, consolidation of the individual features includes combining the features extracted from the compressed data sets. In some examples, the feature combination circuitry 345 is instantiated, in part, by programmable circuitry executing feature combination instructions and/or configured to perform operations such as those represented by the flowcharts of FIG. 4 (block 460) and FIG. 8 (block 830).

In some examples, the geospatial compression circuitry 220 includes means for combining features extracted from a compressed data set. For example, the means for combining features extracted from the compressed data set may be implemented by feature combination circuitry 345. In some examples, the feature combination circuitry 345 may be instantiated by programmable circuitry such as the example programmable circuitry 912 of FIG. 9. For instance, the feature combination circuitry 345 may be instantiated by the example microprocessor 1000 of FIG. 10 executing machine executable instructions such as those implemented by at least block 460 of FIG. 4 and block 830 of FIG. 8. In some examples, the feature combination circuitry 345 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the feature combination circuitry 345 may be instantiated by any other combination of hardware, software, and/or firmware. For example, the feature combination circuitry 345 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The database with output features 350 receives the set of new geospatial features and stores them. While the database with output features 350 is depicted as separate from the database with tabular geospatial data 322, the databases 350 and 322 may be implemented as the same database or separate databases. These example databases 350 and 322 may be one or more mass storage discs or devices to store firmware, software, and/or data. Examples of such mass storage discs or devices 350 and 322 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

Then, the data processing circuitry 355 accesses the database with output features 350. The data processing circuitry 355 may perform several functions. The data processing circuitry 355 may format the data for display or send the data for further processing and analysis of features for extraction. Further processing may also be performed by the data processing circuitry 355. In some examples, further processing may be performed for numerous machine learning methodologies or tasks includes prediction, forecasting, clustering, causal analysis, and comparison. As used herein, clustering is defined as grouping data into defined categories and/or assignment of defined labels to data indicative of a respective class or category. In some examples, the data for the plot of land is stored in a graph structure allowing expression of adjacency information. Typically, the data is converted into a graph after conversion through a geospatial bucketing technique, as described below. In this example, after bucketing the data into H3 hexagons the data came be made into a graph structure of the hexes grid to store nodes, their neighbors, and any sort of edge weights between them, such as differences in value of the nodes. Then, on these graph structures, graph segmentation or community detection algorithms may be implemented to find highly interconnected regions in the graph. These highly interconnected regions may equate to agronomic subzones in the field. The output of these analyses can be sent to the database with output features 350 for later use. In some examples, the data processing circuitry 355 is instantiated, in part, by programmable circuitry executing data processing instructions and/or configured to perform operations such as those represented by the flowcharts of FIG. 4 (block 470) and FIG. 8 (blocks 840-850).

In some examples, the geospatial compression circuitry 220 includes means for performing further processing on an extracted feature set. For example, the means for performing further processing on the extracted feature set may be implemented by data processing circuitry 355. In some examples, the data processing circuitry 355 may be instantiated by programmable circuitry such as the example programmable circuitry 912 of FIG. 9. For instance, the data processing circuitry 355 may be instantiated by the example microprocessor 1000 of FIG. 10 executing machine executable instructions such as those implemented by at least block 470 of FIG. 4 and blocks 840-850 of FIG. 8. In some examples, the data processing circuitry 355 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the data processing circuitry 355 may be instantiated by any other combination of hardware, software, and/or firmware. For example, the data processing circuitry 355 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

Then, once processing is completed, the set of geospatial features is sent to the display circuitry 360. In some examples, the display circuitry 260 displays the compressed data set and/or the set of geospatial features. The output device(s), display circuitry 360, can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. In some examples, the display circuitry 360 is instantiated, in part, by programmable circuitry executing display instructions and/or configured to perform operations such as those represented by the flowcharts of FIG. 4 (blocks 470-480) and FIG. 8 (block 850).

In some examples, the geospatial compression circuitry 220 includes means for displaying a compressed data set and/or a set of geospatial features. For example, the means for displaying the compressed data set and/or the set of geospatial features may be implemented by display circuitry 360. In some examples, the display circuitry 360 may be instantiated by programmable circuitry such as the example programmable circuitry 912 of FIG. 9. For instance, the display circuitry 360 may be instantiated by the example microprocessor 1000 of FIG. 10 executing machine executable instructions such as those implemented by at least blocks 470-480 of FIG. 4 and block 850 of FIG. 8. In some examples, the display circuitry 360 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the display circuitry 360 may be instantiated by any other combination of hardware, software, and/or firmware. For example, the display circuitry 360 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the geospatial data compression circuitry 220 of FIG. 2 is illustrated in FIG. 3, one or more of the elements, processes, and/or devices illustrated in FIG. 3 may be combined, divided, re-arranged, omitted, eliminated, and/or implemented in any other way. Further, the user/API interface circuitry 310, the requesting processing circuitry 315, the data and model acquisition circuitry 320, the database with tabular geospatial data 322, the geospatial representation code repository circuitry 324, the compression circuitry 330, the output processing circuitry 335, the feature extraction circuitry 340, the feature combination circuitry 345, the database with output features 350, the data processing circuitry 355, the display circuitry 360, the output circuitry 365, and/or, more generally, the example geospatial data compression circuitry 220 of FIG. 3, may be implemented by hardware alone or by hardware in combination with software and/or firmware. Thus, for example, any of the user/API interface circuitry 310, the requesting processing circuitry 315, the data and model acquisition circuitry 320, the database with tabular geospatial data 322, the geospatial representation code repository circuitry 324, the compression circuitry 330, the output processing circuitry 335, the feature extraction circuitry 340, the feature combination circuitry 345, the database with output features 350, the data processing circuitry 355, the display circuitry 360, the output circuitry 365, and/or, more generally, the example geospatial data compression circuitry 220 of FIG. 3, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example geospatial data compression circuitry 220 of FIG. 3 may include one or more elements, processes, and/or devices in addition to, or instead of, those illustrated in FIG. 3, and/or may include more than one of any or all of the illustrated elements, processes and devices.

Flowcharts representative of example machine-readable instructions, which may be executed by programmable circuitry to implement and/or instantiate the geospatial data compression circuitry 220 of FIG. 3 and/or representative of example operations which may be performed by programmable circuitry to implement and/or instantiate the geospatial data compression circuitry 220 of FIG. 3, are shown in FIGS. 4-8. The machine-readable instructions may be one or more executable programs or portion(s) of one or more executable programs for execution by programmable circuitry such as the programmable circuitry 912 shown in the example processor platform 900 discussed below in connection with FIG. 9 and/or may be one or more function(s) or portion(s) of functions to be performed by the example programmable circuitry (e.g., an FPGA) discussed below in connection with FIGS. 10 and/or 11. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIGS. 4-8, many other methods of implementing the example geospatial data compression may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 4-8 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 4 is a flowchart representative of example operations 400 performed by the geospatial compression circuitry 220 of FIG. 2. The process begins at block 410 where tabular geospatial data is accessed. The accessed tabular geospatial data may be responsive to a user request for data from a specific plot of land. Additionally, block 420 may allow user input to select the desired representation type of the tabular geospatial data. Additionally or alternatively, a default data representation type may be selected. Then, the process proceeds to block 430 where a new data representation is produced based on the accessed data and the selected data representation type.

At block 430, the compression circuitry 330 generates an output data representation based on the accessed data and the selected representation type. In some examples, the selected representation type determines a compression technique to be applied. The new data representation may be output in one, several, or all of the representations listed below.

The compression circuitry 330, at block 430, may employ geo-index bucketing. Geo-index bucketing is a transformation process that aggregates tabular geospatial data into standardized geospatial buckets (such as, H3 hexagons, Quadkeys, or S2 quadrilaterals). These standardized geospatial buckets may include a criterion to determine whether certain tabular geospatial data fall into that bucket or another bucket. Optional interpolation features may be activated for heightened precision and smoother value transitions. The compression level achieved with geo-index bucketing depends on the size of geo-index used. For example, L12 hexes result in around 9×, and L8 hexes result in around 2000×. The input to geo-index bucketing is tabular data at 1 Hz or 5 Hz resolution of operation. The data inputs are the georeferenced coordinates of the tabular data corresponding to the queried plot of land by the user for the compression. In some examples, the georeferenced coordinates may include latitude and longitude coordinates. Optional data that may also be compressed by geo-index bucketing includes agronomic conditions such as: yield; soil moisture; soil type; elevation; pounds of nitrogen; and other agronomic, construction, or forestry factors. After geo-index bucketing is performed, the output is tabular data at geo-index resolution. The required data of the output includes a bucket identifier. However, optional data of the output includes aggregated values (such as, mean, median, mode, standard deviation) for the optional data provided in each geo-indexed bucket.

The compression circuitry 330, at block 430, may also employ rasterization. Rasterization is a technique that takes tabular data and transforms the tabular data into a raster format representation. As used herein, a raster is a data format that consists of pixels located in a matrix or grid where each pixel has a value according to its position in the matrix or grid. The compression level achieved with rasterization is dependent on the range of latitude (LAR) and longitude (LOR) coordinates of the plot of land, the resolution selected (R), number of data points in the area (N), and a number of features recorded in the space (F):

$$\frac{N \times F \times {R}^{2}}{LAR \times LOR}$$

The input for rasterization of data includes georeferenced coordinates of the plot of land and the resolution (e.g., size) of the output raster. In some examples, georeferenced coordinates may include latitude and longitude coordinates. Optional inputs includes agronomic conditions such as: yield; soil moisture; soil type; elevation; pounds of nitrogen; and other agronomic, construction, and forestry factors. The output of rasterization is data formatted into the aforementioned raster (e.g., a matrix or grid), and a bounding box of coordinates. This bounding box of coordinates confines the raster to the coordinates of the user queried plot of land.

The compression circuitry 330, at block 430, may employ graph conversion. Graph conversion is a method to represent geospatial data by converting the tabular input data into a graph data structure. Initially, the geospatial data is categorized using one of the available bucketing techniques. The resulting graph's edges mirror the relationships between these categorized sections (e.g., buckets). The compression level achieved with graph conversion is similar to geo-index bucketing as the graph is built on top of the bucketed data made from geo-index bucketing. The input into graph conversion is tabular data compressed first into a geo-index. Optional inputs may include aggregated values (e.g., mean, median, mode, standard deviation) for optional data provided in each geo-index bucket. Then, the output, after graph conversion, is a graph with a node for each geo-index and edges between geo-indices. Additionally, rules may be employed for when edges should be created between adjacent geo-indices, such as if their values are similar enough.

The compression circuitry 330, at block 430, may employ frequency domain conversion. Frequency domain conversion is a representation technique that transforms raw tabular data into a frequency-based raster. By employing a two-dimensional Fast Fourier Transform (2D FFT), frequency domain conversion illustrates the dispersion of frequency components in relation to the fluctuation of geospatial data. The compression level achieved by frequency domain conversion is similar to rasterization. The compression level may be higher or lower depending on filtering or quantizing of high frequency signals. Frequency domain conversion may be particularly useful in circumstances where there are repetitive patterns and textures in the tabular geospatial data set. The input required for frequency domain conversion is tabular data with georeferenced coordinates. In some examples, georeferenced coordinates may include latitude and longitude coordinates. Optional data inputs may include agronomic conditions such as: yield; soil moisture; soil type; elevation; pounds of nitrogen; and other agronomic, construction, and forestry factors. After performance of frequency domain conversion, the output data consists of frequency data where there is a matrix of complex numbers to represent frequencies.

The compression circuitry 330, at block 430, may employ auto-encoder. Auto-encoder is a technique that transforms tabular geospatial data into a condensed raster that retains key information about the plot of land. Auto-encoder leverages neural networks, along with encoder-decoder mechanisms, to produce the resultant embeddings. The compression level achieved with auto-encoder may be a static output size of a 4×4 matrix, regardless of the size of the tabular geospatial data. However, alternative versions of the model can be trained for different size outputs and inputs. The input data required for auto-encoder is tabular data with georeferenced coordinates. In some examples, georeferenced coordinates may include latitude and longitude coordinates. Optional data inputs may include agronomic conditions such as: yield; soil moisture; soil type; elevation; pounds of nitrogen; and other agronomic, construction, and forestry factors. After performance of auto-encoder compression, the output is a fixed size tensor (e.g., 4×4×1). In some examples, autoencoder is applied in machine learning as a type of convolutional neural network.

The compression circuitry 330, at block 430, may employ Gaussian Mixture Model (GMM) conversion. GMM conversion analyzes the distribution of geospatial data to parametrize the tabular geospatial data in terms of georeferenced coordinates. In some examples, georeferenced coordinates may include latitude and longitude coordinates. The compression level achieved with GMM conversion depends on the number of data points (N) with features (F) of the queried plot of land compared to the number of data points (K) with features (D) for a covariance matrix (K×K):

$$\frac{N \times F}{D + ( K \times D ) + ( K \times {D}^{2} )}$$

The input data for GMM conversion requires tabular data with georeferenced coordinates and a size parameter (K) corresponding to the number of representation points desired. In some examples, georeferenced coordinates may include latitude and longitude coordinates. Optional data inputs may include agronomic conditions such as: yield; soil moisture; soil type; elevation; pounds of nitrogen; and other agronomic, construction, and forestry factors. After GMM conversion, the output is a D-dimensional weight vector, K D-dimensional points, and K D×D covariance matrices. In some examples, GMM conversion may be used as a machine learning technique to learn a set of representative points in a plot of land.

After the data is compressed, the process continues based on whether a feature set was requested by the user (block 440). If a feature set was requested, the process proceeds to perform individual feature extraction (block 450) from the compressed data set. However, if the user does not request a feature set, the process ends with the desired new data representation (block 480) as the output.

Individual feature extraction produces a set of geospatial features. Various feature extraction methods may be used including, but not limited to, 2D convolution, max-min pooling, function parameters, extreme values and their range, and graph embeddings. Once individual features are extracted, the individual features are combined (block 460). The combination of the features may be produced by flattening and consolidating the extracted features. In some examples, the features are combined based on the georeferenced coordinates. Once combined, the features correspond to a set of geospatial features (block 470). The set of geospatial features may be a combined feature vector. This vector may be utilized in numerous machine learning methodologies, as described above, for tasks such as prediction, forecasting, clustering, causal analysis, and comparison.

FIG. 5 is a flowchart representative of example machine-readable instructions and/or example operations 500 that may be executed, instantiated, and/or performed by programmable circuitry to perform geospatial data compression. The example machine-readable instructions and/or the example operations 500 of FIG. 5 begin at block 510, at which the determination of data sets from a query is performed. Then, control proceeds to block 520 where the data is compressed according to the user query and the type of data. Last, control proceeds to block 530 where key features are extracted from the compressed data set to result in a set of geospatial features for output.

FIG. 6 is a flowchart representative of example machine-readable instructions and/or example operations 510 that may be executed, instantiated, and/or performed by programmable circuitry to perform the determination of data sets from a query. The example machine-readable instructions and/or example operations 510 of FIG. 6 begin at block 610, at which the tabular geospatial data sets corresponding to the queried plot of land are retrieved. The queried plot of land, as disclosed herein, is a plot of land corresponding to the user input wherein the user wishes information concerning the plot of land to be displayed in the data set. Then, control proceeds to block 620 where weights are assigned to the data sets. The assigning of weights may be based on the method of collection of the data or any other method in which the data may be differentiated. Then, control proceeds to block 630 where the data sets are sorted according to georeferenced coordinates of the queried plot of land. In some examples, georeferenced coordinates may include latitude and longitude coordinates. After the data sets are sorted, control returns to block 520 of FIG. 5.

FIG. 7 is a flowchart representative of example machine-readable instructions and/or example operations 520 that may be executed, instantiated, and/or performed by programmable circuitry to perform the compression of data according to a user query and data type. The example machine-readable instructions and/or example operations 520 of FIG. 7 begin at block 710, at which the type of data sets from the queried plot of land are determined. The type of data set may be, but is not limited to, tabular geospatial data. Then, control proceeds to block 720 where a technique to compress data is determined. The technique to compress data may be either a default selection or based on user input. As disclosed above, this method to compress data may be, but is not limited to, geo-index bucketing, rasterization, graph conversion, frequency domain conversion, auto-encoder, and GMM conversion. After a technique, or techniques, to compress data are selected, control proceeds to block 730 at which the compression technique is run on the data set and a compressed data set is output at block 740. After the compressed data set is output, control returns to block 530 of FIG. 5.

FIG. 8 is a flowchart representative of example machine-readable instructions and/or example operations 530 that may be executed, instantiated, and/or performed by programmable circuitry to perform the extraction of key features from compressed data. The example machine-readable instructions and/or example operations 530 of FIG. 8 begin at block 810, at which a decision is made concerning whether features should be extracted from the compressed data set. If there is no request for feature extraction, then the compressed data set is sent to block 850 to be output to the user interface and or an additional display. If there is a request for feature extraction, control proceeds to block 820 where features are extracted from the compressed data set. As disclosed above, feature extraction may be performed by, but is not limited to, 2D convolution, max-min pooling, function parameters, extreme values and their range, and graph embeddings. Once features are extracted, control proceeds to block 830 where the extracted features from the compressed data sets are combined. In some examples, the extracted features are combined based on georeferenced coordinates of the extracted features. Then, control proceeds to block 840 where a decision is made whether further processing should be performed. If further processing is performed, control returns to block 830 where feature combination and processing is further performed. If no further processing is requested, control returns to block 850 where the set of geospatial features, compressed and extracted, are output to the user interface and the process ends.

FIG. 9 is a block diagram of an example programmable circuitry platform 900 structured to execute and/or instantiate the example machine-readable instructions and/or the example operations of FIGS. 4-8 to implement the geospatial compression circuitry of FIG. 2. The programmable circuitry platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs, microprocessors, CPUs, GPUs, DSPs, and/or microcontrollers from any desired family or manufacturer. The programmable circuitry 912 may be implemented by one or more semiconductor based (e.g., silicon based) devices. In this example, the programmable circuitry 912 implements the geospatial compression circuitry 220, the subzone boundary creation circuitry 230, and the soft boundary creation circuitry 240.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a keyboard, a button, a mouse, a touchscreen, a trackpad, a trackball, an isopoint device, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store firmware, software, and/or data. Examples of such mass storage discs or devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 932, which may be implemented by the machine-readable instructions of FIGS. 4-8, may be stored in the mass storage device 928, in the volatile memory 914, in the non-volatile memory 916, and/or on at least one non-transitory computer-readable storage medium such as a CD or DVD which may be removable.

FIG. 10 is a block diagram of an example implementation of the programmable circuitry 912 of FIG. 9. In this example, the programmable circuitry 912 of FIG. 9 is implemented by a microprocessor 1000. For example, the microprocessor 1000 may be a general-purpose microprocessor (e.g., general-purpose microprocessor circuitry). The microprocessor 1000 executes some or all of the machine-readable instructions of the flowcharts of FIGS. 4-8 to effectively instantiate the circuitry of FIG. 2 as logic circuits to perform operations corresponding to those machine-readable instructions. In some such examples, the circuitry of FIG. 2 is instantiated by the hardware circuits of the microprocessor 1000 in combination with the machine-readable instructions. For example, the microprocessor 1000 may be implemented by multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine-readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine-readable instructions and/or operations represented by the flowcharts of FIGS. 4-8.

The cores 1002 may communicate by a first example bus 1004. In some examples, the first bus 1004 may be implemented by a communication bus to effectuate communication associated with one(s) of the cores 1002. For example, the first bus 1004 may be implemented by at least one of an Inter-Integrated Circuit (I2C) bus, a Serial Peripheral Interface (SPI) bus, a PCI bus, or a PCIe bus. Additionally or alternatively, the first bus 1004 may be implemented by any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2 cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the local memory 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer-based operations. In other examples, the AL circuitry 1016 also performs floating-point operations. In yet other examples, the AL circuitry 1016 may include first AL circuitry that performs integer-based operations and second AL circuitry that performs floating-point operations. In some examples, the AL circuitry 1016 may be referred to as an Arithmetic Logic Unit (ALU).

The registers 1018 are semiconductor-based structures to store data and/or instructions such as results of one or more of the operations performed by the AL circuitry 1016 of the corresponding core 1002. For example, the registers 1018 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure, such as by being distributed throughout the core 1002 to shorten access time. The second bus 1022 may be implemented by at least one of an I2C bus, a SPI bus, a PCI bus, or a PCIe bus.

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages.

The microprocessor 1000 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1000, in the same chip package as the microprocessor 1000 and/or in one or more separate packages from the microprocessor 1000.

FIG. 11 is a block diagram of another example implementation of the programmable circuitry 912 of FIG. 9. In this example, the programmable circuitry 912 is implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine-readable instructions. However, once configured, the FPGA circuitry 1100 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1000 of FIG. 10 described above (which is a general purpose device that may be programmed to execute some or all of the machine-readable instructions represented by the flowchart(s) of FIGS. 4-8 but whose interconnections and logic circuitry are fixed once fabricated), the FPGA circuitry 1100 of the example of FIG. 11 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 4-8. In particular, the FPGA circuitry 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 4-8. As such, the FPGA circuitry 1100 may be configured and/or structured to effectively instantiate some or all of the operations/functions corresponding to the machine-readable instructions of the flowchart(s) of FIGS. 4-8 as dedicated logic circuits to perform the operations/functions corresponding to those software instructions in a dedicated manner analogous to an ASIC. Therefore, the FPGA circuitry 1100 may perform the operations/functions corresponding to the some or all of the machine-readable instructions of FIGS. 4-8 faster than the general-purpose microprocessor can execute the same.

In the example of FIG. 11, the FPGA circuitry 1100 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain a binary file, which may be implemented by a bit stream, data, and/or machine-readable instructions, to configure the FPGA circuitry 1100, or portion(s) thereof. In some such examples, the configuration circuitry 1104 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof. In some examples, the external hardware 1106 may be implemented by external hardware circuitry. For example, the external hardware 1106 may be implemented by the microprocessor 1000 of FIG. 10.

The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations/functions that may correspond to at least some of the machine-readable instructions of FIGS. 4-8 and/or other desired operations. The logic gate circuitry 1108 shown in FIG. 11 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations/functions. The logic gate circuitry 1108 may include other electrical structures such as look-up tables (LUTs), registers (e.g., flip-flops or latches), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example dedicated operations circuitry 1114. In this example, the dedicated operations circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the programmable circuitry 912 of FIG. 9, many other approaches are contemplated. For example, FPGA circuitry may include an on-board CPU, such as one or more of the example CPU 1120 of FIG. 10. Therefore, the programmable circuitry 912 of FIG. 9 may additionally be implemented by combining at least the example microprocessor 1000 of FIG. 10 and the example FPGA circuitry 1100 of FIG. 11. In some such hybrid examples, one or more cores 1002 of FIG. 10 may execute a first portion of the machine-readable instructions represented by the flowchart(s) of FIGS. 4-8 to perform first operation(s)/function(s), the FPGA circuitry 1100 of FIG. 11 may be configured and/or structured to perform second operation(s)/function(s) corresponding to a second portion of the machine-readable instructions represented by the flowcharts of FIGS. 4-8, and/or an ASIC may be configured and/or structured to perform third operation(s)/function(s) corresponding to a third portion of the machine-readable instructions represented by the flowcharts of FIGS. 4-8.

It should be understood that some or all of the circuitry of FIG. 2 may, thus, be instantiated at the same or different times. For example, same and/or different portion(s) of the microprocessor 1000 of FIG. 10 may be programmed to execute portion(s) of machine-readable instructions at the same and/or different times. In some examples, same and/or different portion(s) of the FPGA circuitry 1100 of FIG. 11 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1000 of FIG. 10 may execute machine-readable instructions in one or more threads executing concurrently and/or in series. In some examples, the FPGA circuitry 1100 of FIG. 11 may be configured and/or structured to carry out operations/functions concurrently and/or in series. Moreover, in some examples, some or all of the circuitry of FIG. 2 may be implemented within one or more virtual machines and/or containers executing on the microprocessor 1000 of FIG. 10.

In some examples, the programmable circuitry 912 of FIG. 9 may be in one or more packages. For example, the microprocessor 1000 of FIG. 10 and/or the FPGA circuitry 1100 of FIG. 11 may be in one or more packages. In some examples, an XPU may be implemented by the programmable circuitry 912 of FIG. 9, which may be in one or more packages. For example, the XPU may include a CPU (e.g., the microprocessor 1000 of FIG. 10, the CPU 1120 of FIG. 11, etc.) in one package, a DSP (e.g., the DSP 1122 of FIG. 11) in another package, a GPU in yet another package, and an FPGA (e.g., the FPGA circuitry 1100 of FIG. 11) in still yet another package.

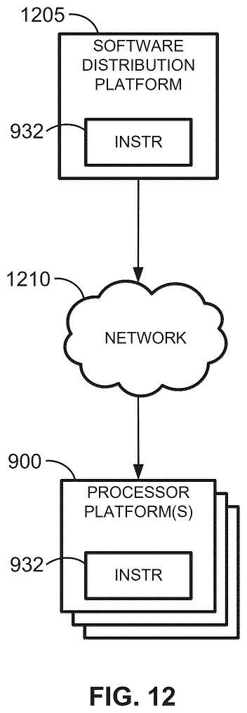

A block diagram illustrating an example software distribution platform 1205 to distribute software such as the example machine-readable instructions 932 of FIG. 9 to other hardware devices (e.g., hardware devices owned and/or operated by third parties from the owner and/or operator of the software distribution platform) is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. For example, the entity that owns and/or operates the software distribution platform 1205 may be a developer, a seller, and/or a licensor of software such as the example machine-readable instructions 932 of FIG. 9. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the machine-readable instructions 932, which may correspond to the example machine-readable instructions of FIGS. 4-8, as described above. The one or more servers of the example software distribution platform 1205 are in communication with an example network 1210, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 932 from the software distribution platform 1205. For example, the software, which may correspond to the example machine-readable instructions of FIG. 4-8, may be downloaded to the example programmable circuitry platform 900, which is to execute the machine-readable instructions 932 to implement the geospatial compression circuitry. In some examples, one or more servers of the software distribution platform 1205 periodically offer, transmit, and/or force updates to the software (e.g., the example machine-readable instructions 932 of FIG. 9) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real-world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that compress tabular geospatial data that may later be used to aid vehicle operation. Disclosed systems, apparatus, articles of manufacture, and methods improve the efficiency of using a computing device by compressing tabular geospatial data sets with an option to implement feature extraction. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to perform subzone boundary creation to determine the travel of a vehicle are disclosed herein. Further examples and combinations thereof include the following:
Example 1 includes a non-transitory computer-readable medium comprising instructions which, when executed, cause processor circuitry to cause compression of first data and second data responsive to a query to compress data for a plot of land using a compression technique, the compression of the first data and the second data to generate a first compressed data set and a second compressed data set, extract features from the first compressed data set and the second compressed data set, and combine features from the first compressed data set and the second compressed data set to generate a set of geospatial features.
Example 2 includes the non-transitory computer-readable medium of example 1, wherein the compression technique for the first data set and the second data set is based on a type of the data responsive to the query.
Example 3 includes the non-transitory computer-readable medium of example 1 and example 2, wherein the extraction of features from the first compressed data set and a second compressed data set is performed by at least one of 2D convolution, max-min pooling, function parameters, extreme values, and graph embeddings.
Example 4 includes the non-transitory computer-readable medium of examples 1-3, wherein the set of geospatial features is a combined feature vector representative of the first compressed data set and the second compressed data set.
Example 5 includes the non-transitory computer-readable medium of examples 1-4, wherein the processor circuitry is to analyze the set of geospatial features through machine learning.
Example 6 includes the non-transitory computer-readable medium of examples 1-5, wherein the processor circuitry is to assign weights to the first data and the second data based on a method of collection of the first data and the second data responsive to the query, wherein the compression of the first data and the second data is based on the assigned weights.
Example 7 includes the non-transitory computer-readable medium of examples 1-6, wherein the first data and the second data include georeferenced coordinates and agronomic conditions of the plot of land based on at least one of yield, soil moisture, soil type, elevation, pounds of nitrogen, forestry conditions, and construction conditions.
Example 8 includes an apparatus to compress geospatial data, comprising interface circuitry, memory, at least one processor circuit to at least one of instantiate or execute machine-readable instructions to cause compression of first data and second data responsive to a query to compress data for a plot of land using a compression technique, the compression of the first data and the second data to generate a first compressed data set and a second compressed data set, extract features from the first compressed data set and the second compressed data set, and combine features from the first compressed data set and the second compressed data set to generate a set of geospatial features.
Example 9 includes the apparatus of example 8, wherein the compression technique for the first data set and the second data set is based on a type of the data responsive to the query.
Example 10 includes the apparatus of example 8 and example 9, wherein one or more of the at least one processor circuit is to extract features from the first compressed data set and a second compressed data set by at least one of 2D convolution, max-min pooling, function parameters, extreme values, and graph embeddings.
Example 11 includes the apparatus of examples 8-10, wherein the set of geospatial features is a combined feature vector representative of the first compressed data set and the second compressed data set.
Example 12 includes the apparatus of examples 8-11, wherein one or more of the at least one processor circuit is to analyze the set of geospatial features using machine learning.
Example 13 includes the apparatus of examples 8-12, wherein one or more of the at least one processor circuit is to assign weights to the first data and the second data based on a method of collection of first data and second data responsive to the query, wherein the compression of the first data and the second data is based on the assigned weights.
Example 14 includes the apparatus of examples 8-13, wherein the first data set and the second data set include georeferenced coordinates and agronomic conditions of the plot of land based on at least one of yield, soil moisture, soil type, elevation, pounds of nitrogen, forestry conditions, and construction conditions.
Example 15 includes a method to compress geospatial data, comprising compressing first data and second data responsive to a query to compress data for a plot of land using a compression technique, the compression of the first data and the second data to generate a first compressed data set and a second compressed data set, extracting features from the first compressed data set and the second compressed data set, and combining features from the first compressed data set and the second compressed data set to generate a set of geospatial features.
Example 16 includes the method of example 15, wherein the compression technique for the first data set and the second data set is based on a type of the data responsive to the query.
Example 17 includes the method of example 15 and example 16, wherein the set of geospatial features is a combined feature vector representative of the first compressed data set and the second compressed data set.
Example 18 includes the method of examples 15-17, further including analyzing the set of geospatial features using machine learning.
Example 19 includes the method of examples 15-18, further including assigning weights to the first data and the second data based on the method of collection of the first data and the second data responsive to the query, wherein the compression of the first data and the second data is based on the assigned weights.
Example 20 includes the method of examples 15-19, wherein the first data and the second data include georeferenced coordinates and agronomic conditions of the plot of land based on at least one of yield, soil moisture, soil type, elevation, pounds of nitrogen, forestry conditions, and construction conditions.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A non-transitory computer-readable medium comprising instructions which, when executed, cause processor circuitry to:
cause compression of first data and second data responsive to a query to compress data for a plot of land using a compression technique, the compression of the first data and the second data to generate a first compressed data set and a second compressed data set;
extract features from the first compressed data set and the second compressed data set; and
combine features from the first compressed data set and the second compressed data set to generate a set of geospatial features.

2. The non-transitory computer-readable medium of claim 1, wherein the compression technique for the first data set and the second data set is based on a type of the data responsive to the query.

3. The non-transitory computer-readable medium of claim 1, wherein the extraction of features from the first compressed data set and a second compressed data set is performed by at least one of 2D convolution, max-min pooling, function parameters, extreme values, and graph embeddings.

4. The non-transitory computer-readable medium of claim 1, wherein the set of geospatial features is a combined feature vector representative of the first compressed data set and the second compressed data set.

5. The non-transitory computer-readable medium of claim 1, wherein the instructions cause the processor circuitry to analyze the set of geospatial features through machine learning.

6. The non-transitory computer-readable medium of claim 1, wherein the instructions cause the processor circuitry to assign weights to the first data and the second data based on a method of collection of the first data and the second data responsive to the query, wherein the compression of the first data and the second data is based on the assigned weights.

7. The non-transitory computer-readable medium of claim 1, wherein the first data and the second data include georeferenced coordinates and agronomic conditions of the plot of land based on at least one of yield, soil moisture, soil type, elevation, pounds of nitrogen, forestry conditions, and construction conditions.

8. An apparatus to compress geospatial data, comprising:
interface circuitry;
memory;
at least one processor circuit to at least one of instantiate or execute machine-readable instructions to:
cause compression of first data and second data responsive to a query to compress data for a plot of land using a compression technique, the compression of the first data and the second data to generate a first compressed data set and a second compressed data set;
extract features from the first compressed data set and the second compressed data set; and
combine features from the first compressed data set and the second compressed data set to generate a set of geospatial features.

9. The apparatus of claim 8, wherein the compression technique for the first data set and the second data set is based on a type of the data responsive to the query.

10. The apparatus of claim 8, wherein one or more of the at least one processor circuit is to extract features from the first compressed data set and a second compressed data set by at least one of 2D convolution, max-min pooling, function parameters, extreme values, and graph embeddings.

11. The apparatus of claim 8, wherein the set of geospatial features is a combined feature vector representative of the first compressed data set and the second compressed data set.

12. The apparatus of claim 8, wherein one or more of the at least one processor circuit is to analyze the set of geospatial features using machine learning.

13. The apparatus of claim 8, wherein one or more of the at least one processor circuit is to assign weights to the first data and the second data based on a method of collection of first data and second data responsive to the query, wherein the compression of the first data and the second data is based on the assigned weights.

14. The apparatus of claim 8, wherein the first data set and the second data set include georeferenced coordinates and agronomic conditions of the plot of land based on at least one of yield, soil moisture, soil type, elevation, pounds of nitrogen, forestry conditions, and construction conditions.

15. A method to compress geospatial data, comprising:
compressing first data and second data responsive to a query to compress data for a plot of land using a compression technique, the compression of the first data and the second data to generate a first compressed data set and a second compressed data set;
extracting features from the first compressed data set and the second compressed data set; and
combining features from the first compressed data set and the second compressed data set to generate a set of geospatial features.

16. The method of claim 15, wherein the compression technique for the first data set and the second data set is based on a type of the data responsive to the query.

17. The method of claim 15, wherein the set of geospatial features is a combined feature vector representative of the first compressed data set and the second compressed data set.

18. The method of claim 15, further including analyzing the set of geospatial features using machine learning.

19. The method of claim 15, further including assigning weights to the first data and the second data based on the method of collection of the first data and the second data responsive to the query, wherein the compression of the first data and the second data is based on the assigned weights.

20. The method of claim 15, wherein the first data and the second data include georeferenced coordinates and agronomic conditions of the plot of land based on at least one of yield, soil moisture, soil type, elevation, pounds of nitrogen, forestry conditions, and construction conditions.
